(19) United States
(12) Patent Application Publication
(10) Pub. No.: US 2009/0264612 A1
(43) Pub. Date: Oct. 22, 2009

(54) ALKOXYSILANE-TERMINATED PREPOLYMERS

(75) Inventors: Volker Stanjek, Munchen (DE); Christoph Briehn, Munchen (DE); Richard Weidner, Burghausen (DE); Carolin Kinzler, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/721,105

(22) PCT Filed: Nov. 17, 2005
(86) PCT No.: PCT/EP05/12330

§ 371 Date: Jul. 11, 2007

(30) Foreign Application Priority Data
Dec. 9, 2004 (DE) 10 2004 059 379.5

(51) Int. Cl. C08G 77/26; C07F 7/10

(52) U.S. Cl. 528/38; 556/414; 556/407; 556/413

(57) ABSTRACT

Alkoxysilyl-terminated prepolymers in which the alkoxysilyl group is linked to a tertiary nitrogen group through a Cl carbon spacer exhibit excellent moisture curing reactivity and yet are easily prepared. The tertiary nitrogen group-containing α-aminoalkoxysilyl group is introduced into the prepolymer by reacting a tertiary nitrogen group-containing α-aminoalkoxysilane with an isocyanate-terminated prepolymer or isocyanate-functional precursor thereof.

The invention relates to prepolymers obtainable using aminomethyl-functional alkoxysilanes, to processes for preparing them, and to compositions comprising these prepolymers.

Prepolymer systems which possess reactive alkoxysilyl groups have been known for a long time and are widely used for producing elastic sealants and adhesives in the industrial and construction sectors. In the presence of atmospheric moisture and appropriate catalysts, these alkoxysilane-terminated prepolymers are capable even at room temperature of undergoing condensation with one another, with the elimination of the alkoxy groups and the formation of Si—O—Si bonds. Consequently these prepolymers can be used, inter alia, as one-component air-curing systems, which possess the advantage of ease of handling, since there is no need to measure out and mix in a second component.

A further advantage of alkoxysilane-terminated prepolymers lies in the fact that curing is accompanied by the release neither of acids nor of oximes or amines. Nor, in contrast to the case with isocyanate-based adhesives or sealants, is any CO₂ produced, which as a gaseous component can lead to bubbles forming. In contrast to isocyanate-based systems, alkoxysilane-terminated prepolymer mixtures are also toxicologically unobjectionable.

Depending on the amount of alkoxysilane groups and on their structure, the curing of this type of prepolymer is accompanied by the formation principally of long-chain polymers (thermoplastics), relatively wide-meshed three-dimensional networks (elastomers) or else highly crosslinked systems (thermosets).

Alkoxysilane-functional prepolymers may be composed of different units. They typically possess an organic backbone; in other words they are composed, for example, of polyurethanes, polyethers, polyesters, polyacrylates, polyvinyl esters, ethylene-olefin copolymers, styrene-butadiene copolymers or polyolefins, described inter alia in U.S. Pat. No. 6,207,766 and U.S. Pat. No. 3,971,751. In addition, however, systems whose backbone is composed entirely or at least partly of organosiloxanes are also widespread, and are described inter alia in U.S. Pat. No. 5,254,657.

Of central importance to the prepolymer preparation, however, are the monomeric alkoxysilanes via which the prepolymer is furnished with the necessary alkoxysilane functions. In this context it is possible in principle to employ any of a very wide variety of silanes and coupling reactions: for example, the addition reaction of Si—H-functional alkoxysilanes with unsaturated prepolymers, or the copolymerization of unsaturated organosilanes with other unsaturated monomers.

In another process, alkoxysilane-terminated prepolymers are prepared by reaction of OH-functional prepolymers with isocyanate-functional alkoxy silanes. Systems of this kind are described for example in U.S. Pat. No. 5,068,304. The resulting prepolymers often feature particularly positive properties, such as very good mechanical properties in the cured compositions, for example. Disadvantageous, however, are the costly and complicated preparation of the isocyanate-functional silanes and the fact that these silanes are extremely objectionable from a toxicological standpoint.

Often more favorable in this case is a preparation process for alkoxysilane-terminated prepolymers that starts from polyols, such as from polyether- or polyesterpolyols. These polyols react in a first reaction step with an excess of a di- or polyisocyanate. The resulting isocyanate-terminated prepolymers are subsequently reacted with an amino-functional alkoxysilane to give the desired alkoxysilane-terminated prepolymer. Systems of this kind are described for example in EP 1 256 595 or EP 1 245 601. The advantages of this system lie above all in the particularly positive properties of the resultant prepolymers. For example, these prepolymers are generally distinguished by high tensile strength in the cured compositions, which is attributable—at least in part—to the urethane and urea units that are present in these polymers, and to their capacity to form hydrogen bonds. Another advantage of these prepolymer systems is the fact that the amino-functional silanes required as reactants are available through simple and inexpensive processes and are largely unobjectionable from the toxicological standpoint.

A disadvantage of the majority of systems known and used at present, however, is their no more than moderate reactivity toward moisture, either in the form of atmospheric moisture or in the form of water, whether present already or added. In order to achieve a sufficient cure rate even at room temperature, therefore, it is vital to add a catalyst. The principal reason why this presents problems is that the organotin compounds generally employed as catalysts are toxicologically objectionable. Moreover, the tin catalysts often still contain traces of highly toxic tributyltin derivatives as well.

A particular problem is the relatively low reactivity of the alkoxysilane-terminated prepolymer systems when the terminations used are not methoxysilyls but instead the even less reactive ethoxysilyls. Ethoxysilyl-terminated prepolymers specifically, however, would be particularly advantageous in many cases, since their curing is accompanied by the release only of ethanol as a cleavage product.

In order to avoid problems with toxic tin catalysts, attempts have already been made to look for tin-free catalysts. Consideration might be given here, in particular, to titanium catalysts, such as titanium tetraisopropoxide or bis(acetylacetonato)diisobutyl titanate, which are described for example in EP 0 885 933. These titanium catalysts, though, possess the disadvantage that they cannot usually be used in combination with nitrogen compounds, since in that event the latter compounds act as catalyst poisons. In many cases, however, the use of nitrogen compounds is unavoidable, as adhesion promoters, for example. Moreover, in many cases, nitrogen compounds, aminosilanes for example, serve as reactants in the preparation of the silane-terminated prepolymers, and hence are present as virtually unavoidable impurities even in prepolymers themselves.

A great advantage may therefore be represented by alkoxysilane-terminated prepolymer systems of the kind described for example in DE 101 42 050 or DE 101 39 132. A feature of these prepolymers is that they contain alkoxysilyl groups separated only by one methyl spacer from a nitrogen atom having a free electron pair. As a result, these prepolymers possess extremely high reactivity toward (atmospheric) moisture, and so can be processed to prepolymer blends which do not require metal catalysts and yet cure at room temperature with, in some cases, extremely short tack-free times and/or at a very high rate. Since, therefore, these prepolymers possess an amine function in the position α to the silyl group, they are also referred to as α-alkoxysilane-terminated prepolymers.

These α-alkoxysilane-terminated prepolymers are typically prepared by reaction of an α-aminosilane, i.e., of an aminomethyl-functional alkoxysilane, with an isocyanate-functional prepolymer or with an isocyanate-functional precursor of the prepolymer. Commonplace examples of α-aminosilanes are N-cyclohexylaminomethyltrimethoxysilane, N-cyclohexylaminomethylmethyldimethoxysilane, N-ethylaminomethyltrimethoxysilane, N-ethylaminomethylmethyldimethoxysilane, N-butylaminomethyltrimethoxysilane, N-cyclohexylaminomethyltriethoxysilane, N-cyclohexylaminomethylmethyldiethoxysilane, etc.

A critical disadvantage of these α-alkoxysilane-functional systems, however, is the stability, no more than moderate, of the α-aminosilanes required for their synthesis. For instance, the Si—C bond of these silanes, in particular, can be cleaved in some cases very easily. Stability problems of comparable magnitude are unknown for the conventional γ-aminopropylalkoxysilanes.

This instability on the part of the α-aminosilanes is manifested with particular clarity in the presence of alcohol or water. For example, aminomethyltrimethoxysilane in the presence of methanol undergoes quantitative degradation to tetramethoxysilane within a few hours. With water it reacts to give tetrahydroxysilane or to give higher condensation products of this silane. Correspondingly, aminomethylmethyldimethoxysilane reacts with methanol to give methyltrimethoxysilane and with water to give methyltrihydroxysilane or higher condensation products of this silane. Somewhat more stable are N-substituted α-aminosilanes, e.g., N-cyclohexylaminomethylmethyldimethoxysilane or N-cyclohexylaminomethyltrimethoxysilane. Yet in the presence of traces of catalysts, or of acidic and basic impurities, these silanes too undergo quantitative degradation by the methanol within a few hours, to give N-methylcyclohexylamine and methyltrimethoxysilane or tetramethoxysilane, respectively. With water they react to give N-methylcyclohexylamine and methyltrihydroxysilane or tetrahydroxysilane, or the homologs of these silanes with higher degrees of condensation. Even the majority of other N-substituted α-aminosilanes with a secondary nitrogen atom, in accordance with the prior art, exhibit the same degradation reaction.

Even in the absence of methanol or water, however, these α-aminosilanes have no more than moderate stability. For instance, particularly at elevated temperatures and in the presence of catalysts or catalytically active impurities, there may likewise be decomposition of the α-silanes with cleavage of the Si—C bond.

The no more than moderate stability of the α-aminosilanes usually also has severely deleterious consequences because of the fact that they may undergo at least partial decomposition even under the reaction conditions of the prepolymer synthesis. This fact not only hinders the prepolymer synthesis but also leads in general to a deterioration—in some cases a drastic deterioration—in the polymer properties: the prepolymers formed include some which have been terminated not with the aminosilanes but instead by their decomposition products.

The only α-aminosilanes that are somewhat more stable are those having a secondary nitrogen atom that carry on the nitrogen atom an electron-withdrawing substituent, such as, for example, N-phenylaminomethyltrimethoxysilane or O-methylcarbamatomethyltrimethoxysilane. However, the amino functions of these silanes are much less reactive even toward isocyanate groups, which is why they are generally unsuited to the preparation of silane-terminated prepolymers from isocyanate-functional precursors. For instance, the abovementioned O-methylcarbamatomethyltrimethoxysilane is so tardy in its reaction that, even after this silane has been boiled for several hours with a prepolymer possessing aliphatic isocyanate groups, it is virtually impossible to detect any reaction. Even catalysts such as dibutyltin dilaurate provide no notable improvement in this case. Only the N-phenyl-substituted silanes such as N-phenylaminomethyltrimethoxysilane possess a certain (albeit often still inadequate) reactivity toward isocyanate functions. They do, however, undergo reaction to form aromatically substituted urea units, which can enter into photo-Fries rearrangement and are therefore extremely UV-labile. For the great majority of applications, therefore, the corresponding products are totally unsuitable.

The object was therefore to provide prepolymers (A) having a high reactivity toward (atmospheric) moisture that can be prepared from aminomethyl-functional α-alkoxysilanes which on the one hand are distinguished by improved stability but on the other hand are sufficiently reactive toward isocyanate-functional precursors of the prepolymers (A).

The invention provides alkoxysilane-functional prepolymers (A) obtainable by using an aminomethyl-functional alkoxysilane (A1) which possesses at least one structural element of the general formula [1]

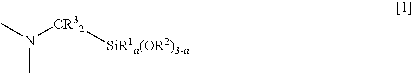

in which
R¹ is an optionally substituted hydrocarbon radical or a ═N—CR³₂ group,
R² is an alkyl radical having 1-6 carbon atoms or an ω-oxaalkyl-alkyl radical having in total 2-10 carbon atoms,
R³ is hydrogen or an optionally substituted hydrocarbon radical, and
a may adopt the values 0, 1 or 2,
   the nitrogen atom in the general [1] being a tertiary nitrogen atom and the alkoxysilane (A1) possessing at least one further isocyanate-reactive function (F).

Surprisingly it has been found that α-aminomethylsilanes which possess a tertiary nitrogen atom in the position α to the silyl group are completely stable under the conditions described. The α-aminosilanes (A) are significantly more stable than conventional α-aminosilanes with a primary or secondary amino function in the position α to the silyl group. For example, the silanes N-(methyldiethoxysilylmethyl)piperazine, N-(methyldimethoxysilylmethyl)piperazine or N-(trimethoxysilylmethyl)piperazine are stable for several weeks even in methanolic solution (10% by weight).

Conventional aminomethyl-functional alkoxysilanes with a primary or secondary amine function, under the same conditions, have largely undergone decomposition after just a short time. Listed below are some typical half-lives of conventional α-aminosilanes:
aminomethylmethyldimethoxysilane: t_{1/2}=6 h
cyclohexylaminomethylmethyldimethoxysilane: t_{1/2}=1 week
aminomethyltrimethoxysilane: t_{1/2}=19 h
cyclohexylaminomethyltrimethoxysilane: t_{1/2}=3 days
isobutylaminomethyltrimethoxysilane: t_{1/2}=1 week

The decomposition of the α-aminomethylsilanes in these cases was detected NMR-spectroscopically.

Conventional α-aminosilanes with a tertiary nitrogen atom, however, such as N,N-diethylaminomethyltrimethoxysilane, N,N-dibutylaminomethyltrimethoxysilane, N,N-diethylaminomethyltriethoxysilane, N,N-dibutylaminomethyltriethoxysilane, etc., are unable, on account of the absent NH function, to be processed any longer with isocyanate-functional precursors to give α-alkoxysilane-functional prepolymers.

The invention is therefore also based on the concept of using α-aminomethylsilanes for the prepolymer synthesis that in the position α to the silyl group possess a tertiary nitrogen atom but that also contain at least one further isocyanate-reactive function (F).

The radicals R¹ have preferably 1 to 12, in particular 1 to 6, C atoms. They are preferably alkyl, cycloalkyl, aryl or arylalkyl radicals. Preference as radicals R¹ is given to methyl, ethyl or phenyl groups, particular preference to the methyl group. The radicals R² are preferably methyl or ethyl groups. The radicals R³ are preferably hydrogen or an optionally chlorine- or fluorine-substituted hydrocarbon radical having 1 to 6 C atoms, especially hydrogen. The function (F) is preferably an NH, OH or SH function.

Preferred alkoxysilanes (A) are those of the general formulae [2] and [3]

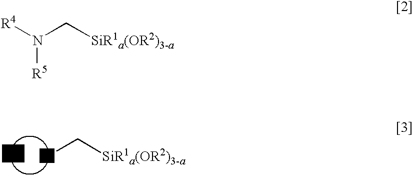

where
R⁴ is an optionally substituted alkyl, aryl or arylalkyl radical which possesses at least one carboxyl or carbonyl group or an isocyanate-reactive OH, SH or NHR⁷ group, it being possible for the alkyl chain to be interrupted optionally by oxygen, carbonyl groups, sulfur or NR7 groups,
R⁵ is an optionally substituted alkyl, aryl or arylalkyl radical, it being possible for the alkyl chain to be interrupted optionally by oxygen, carbonyl groups, sulfur or NR⁷ groups, or is a radical R⁴,
R⁶ is a difunctional, optionally substituted alkyl or arylalkyl radical which either in the alkyl chain possesses carbonyl group or an isocyanate-reactive NH function or an NR⁴ function, or is substituted by at least one isocyanate-reactive OH, SH or NHR⁷ group, it being possible for the alkyl chain to be interrupted optionally by oxygen, sulfur, NR7 groups or carbonyl groups,
R⁷ is hydrogen or an optionally substituted alkyl, aryl or arylalkyl radical, and
R¹, R², and a are as defined for the general formula [1].

Preferred radicals R⁴ are alkyl radicals having 2-10 carbon atoms that possess an OH function or monoalkylamino group, monoalkylamino groups being particularly preferred. Preferred radicals R⁵ are alkyl groups having 1-6 carbon atoms. Preferred radicals R⁶ are difunctional alkyl radicals having 2-10 carbon atoms that possess an NH function in the alkyl chain.

One particularly preferred embodiment of the invention uses as the silane (A1) at least one compound of the general formula [4]

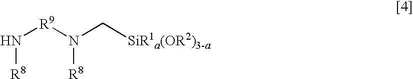

where
R⁸ is alkyl radical having 1-4 carbon atoms, preferably methyl or ethyl, and
R⁹ is a difunctional alkyl radical having 2-10, preferably 2-6, carbon atoms, and
R¹, R² and a are as defined for the general formula [1].

A further particularly preferred embodiment of the invention uses as the silane (A1) at least one compound of the general formula [5] or [6]

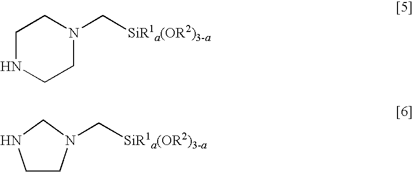

where R¹, R² and a are as defined for the general formula [1].

The silanes (A1) are prepared preferably by the reaction of the corresponding α-halomethylalkoxysilanes, with particular preference the α-chloromethylalkoxysilanes, with secondary amines. In this reaction the chlorine atom of the α-chlorosilane becomes substituted by the respective secondary amine. This may take place either with or without catalyst, though preferably the reaction is carried out without catalyst. The reaction can be carried out either in bulk or in a solvent. The amine may serve simultaneously as an acid scavenger for the hydrogen halide that is liberated in the course of the nucleophilic substitution. Here, however, it is also possible to add another acid scavenger. In one preferred version of the silane preparation the silane is employed in excess.

The silanes used with preference, of the formula [4], can in one particularly advantageous process be prepared by reacting a diamine of the general formula [7]

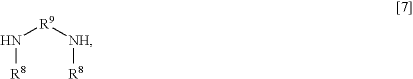

where R⁸ and R⁹ are as defined for the general formula [4], with the corresponding α-halomethylsilane.

For the preparation of the particularly preferred silanes of the general formulae [5] or [6] it is possible, in a corresponding reaction, to start from piperazine or from tetrahydroimidazole, respectively.

The prepolymers (A) of the invention are preferably prepared by subjecting one or more silanes of the general formulae [1] to [6]
a) to reaction with an isocyanate-terminated prepolymer (A2), or
b) to reaction with an NCO-containing precursor of the prepolymer (A) to give a silyl-containing precursor, which is then reacted in further reaction steps to give the completed prepolymer (A).

In this process the proportions of the individual components are preferably selected such that all of the isocyanate groups present in the reaction mixture are consumed by reaction. The resultant prepolymers (A) are therefore preferably isocyanate-free.

In the course of the reaction of the silanes (A1) to give silane-terminated prepolymers (A) they are preferably reacted with isocyanate-terminated prepolymers (A2). The latter are obtainable, for example, through a reaction of one or more polyols (A21) with an excess of di- or polyisocyanates (A22 ).

In this case it is of course also possible to reverse the sequence of the reaction steps; in other words, the silanes (A1) are reacted in a first reaction step with an excess of one or more di- or polyisocyanates (A22) and only in the second reaction step is the polyol component (A21) added.

Polyols (A21) that can be used for preparing the prepolymers (A) are in principle all polyols having an average molecular weight Mn of 1000 to 25 000. These may be, for example, hydroxyl-functional polyethers, polyesters, polyacrylates and polymethacrylates, polycarbonates, polystyrenes, polysiloxanes, polyamides, polyvinyl esters, polyvinyl hydroxides or polyolefins such as polyethylene, polybutadiene, ethylene-olefin copolymers or styrene-butadiene copolymers, for example.

It is preferred to use polyols (A21) having a molecular weight Mn of 2000 to 25 000, with particular preference of 4000 to 20 000. Particularly suitable polyols (A21) are aromatic and/or aliphatic polyester polyols and polyetherpolyols of the kind widely described in the literature. The polyethers and/or polyesters that are used as polyols (A21) may be either linear or branched, although unbranched, linear polyols are preferred. Furthermore, polyols (A21), may also possess substituents such as halogen atoms, for example. Preferred polyols (A21) are, in particular, polypropylene glycols having masses Mn of 4000 to 20 000, since even at high chain lengths these polyols have comparatively low viscosities.

As polyols (A21) it is also possible to use hydroxyalkyl- or aminoalkyl-terminated polysiloxanes of the general formula [8]

Z-R¹¹—[Si(R¹⁰)₂—O—]ₙ—Si(R¹⁰)₂—R¹¹-Z [8]

in which
R¹⁰ is a hydrocarbon radical having 1 to 12 carbon atoms, preferably methyl radicals,
R¹¹ is a branched or unbranched hydrocarbon chain having 1-12 carbon atoms, preferably —CH₂— or n-propyl,
n is a number from 1 to 3000, preferably a number from 10 to 1000,
Z is an OH group or a group NHR⁷, NR⁴R⁵ or NR⁶, and
R⁴, R⁵, R⁶, and R⁷ are as defined for the general formulae [2] and [3].

As will be appreciated, the use of any desired mixtures of the various types of polyol is also possible.

In one preferred version of the invention low molecular mass diols, such as glycol, the various regioisomers of propanediol, butanediol, pentanediol or hexanediol, for example, are also present in the polyol component (A21). The use of these low molecular mass diols leads to an increase in the urethane group density in the prepolymer (A) and hence to an improvement of mechanical properties of the cured compositions preparable from these prepolymers.

In a further particularly preferred embodiment of the invention the polyol component (A21) additionally contains low molecular mass amino alcohols, such as 2-N-methylaminoethanol, for example. Low molecular mass diamino compounds as well may be present in the polyol component.

The low molecular mass diols, diamino compounds or amino alcohols may be used individually or else as mixtures. In that case they can be used as mixtures with the other components (A21) and can be reacted with the di- or polyisocyanates (A22). Their reaction with the di- or polyisocyanates (A22) may also take place before or after the reaction of the other polyol components (A21).

In one particular version of the preparation of the prepolymers (A) it is also possible first to use the other polyols (A21), the di- or polyisocyanates (A22), and the aminosilanes (A1) to prepare a precursor—usually with a much lower viscosity—of the prepolymers (A), that still possesses free NCO functions. Then, in the final reaction step, the completed prepolymer (A) is prepared from this precursor by addition of the low molecular mass diols, diamino compounds or amino alcohols.

As di- or polyisocyanates (A22) for the preparation of the prepolymers (A) it is possible in principle to use all customary isocyanates of the kind widely described in the literature. Examples of common diisocyanates (A22) are diisocyanatodiphenylmethane (MDI), both in the form of crude or technical MDI and in the form of pure 4,4′ and/or 2,4′ isomers or mixtures thereof, tolylene diisocyanate (TDI) in the form of its various regioisomers, diisocyanatonaphthalene (NDI), isophorone diisocyanate (IPDI), perhydrogenated MDI (H-MDI) or else hexamethylene diisocyanate (HDI). Examples of polyisocyanates (A22) are polymeric MDI (P-MDI), triphenylmethane triisocyanate, or isocyanurate triisocyanates or biuret triisocyanates. All of the di- and/or polyisocyanates (A22) can be used individually or else in mixtures. Preference, however, is given to using exclusively diisocyanates. If the UV stability of the prepolymers (A) or of the cured materials produced from these prepolymers is important on account of the particular application, then it is preferred to use aliphatic isocyanates as component (A22).

The preparation of the prepolymers (A) may take place as a one-pot reaction through a simple combining of the components described, it being possible optionally to add a catalyst and/or to operate at an elevated temperature. On account of the relatively highly exothermic nature of these reactions it may be advantageous to add the individual components in succession, in order to allow the volume of heat evolved to be controlled more effectively. Separate purification or other working-up of the prepolymer (A) is not generally necessary.

The concentrations of all of the isocyanate groups involved in all reaction steps, and of all isocyanate-reactive groups, and also the reaction conditions, are selected here preferably such that, in the course of the prepolymer synthesis, all of the isocyanate groups are consumed by reaction. The completed prepolymer (A) is therefore preferably isocyanate-free. In one preferred embodiment of the invention the concentration ratios and also the reaction conditions are selected such that virtually all of the chain ends (>80% of the chain ends, with particular preference >90% of the chain ends) of the prepolymers (A) are terminated with the alkoxysilyl groups of the general formulae [1] to [6].

In one preferred embodiment of the invention NCO-terminated prepolymers (A2) are reacted with an excess of the silanes (A1). The excess amounts to preferably 10-400%, with particular preference 20-100%. The excess silane (A1) can be added to the prepolymer at any desired point in time, but preferably the silane excess is added during the actual synthesis of the prepolymers (A).

The reactions between isocyanate groups and isocyanate-reactive groups that occur during the preparation of the prepolymers (A) may optionally be accelerated by means of a catalyst. In that case it is preferred to use the same catalysts also listed below as curing catalysts (C). It may even be possible to catalyze the preparation of the prepolymers (A) by means of the same catalysts which act later on, during the curing of the completed prepolymer blends, as curing catalyst (C). This has the advantage that the curing catalyst (C) is already in the prepolymer (A) and need no longer be added separately during the compounding of a completed prepolymer blend (M). As will be appreciated, instead of one catalyst, combinations of two or more catalysts may also be employed.

The use of the prepolymers (A) of the invention, furthermore, has the particular advantage that in this way it is possible as well to prepare prepolymers (A) which contain exclusively ethoxysilyl groups, i.e., silyl groups of the general formulae [1] to [6] in which R² is an ethyl radical. The compositions (M) preparable from these prepolymers are so moisture-reactive that they cure at a sufficiently high rate even without tin catalysts, in spite of the fact that, generally speaking, ethoxysilyl groups are less reactive than the corresponding methoxysilyl groups. Accordingly, tin-free systems are possible even with ethoxysilane-terminated polymers (A). Polymer blends (M) of this kind containing exclusively ethoxysilane-terminated polymers (A) have the advantage that on curing they release only ethanol as a cleavage product. They represent a preferred embodiment of this invention.

The prepolymers (A) are preferably compounded with further components to form mixtures (M). In order to achieve rapid curing of these compositions (M) at room temperature it is possible, optionally, to add a curing catalyst (C). As already mentioned, suitable compounds here include the organotin compounds that are typically used for this purpose, such as, for example, dibutyltin dilaurate, dioctyltin dilaurate, dibutyltin diacetylacetonate, dibutyltin diacetate or dibutyltin dioctoate, etc. In addition it is also possible to use titanates, such as titanium (IV) isopropoxide, iron (III) compounds, such as iron (III) acetylacetonate, or else amines, such as triethylamine, tributylamine, 1,4-diazabicyclo[2.2.2]octane, 1,8-diazabicyclo[5.4.0]-undec-7-ene, 1,5-diazabicyclo[4.3.0]non-5-ene, N,N-bis(N,N-dimethyl-2-aminoethyl)methylamine, N,N-dimethylcyclohexylamine, N,N-dimethylphenylamine, N-ethylmorpholine, etc. Organic or inorganic Brönsted acids, such as acetic acid, trifluoroacetic acid or benzoyl chloride, hydrochloric acid, phosphoric acid and its monoesters and/or diesters, such as butyl phosphate, (iso)propyl phosphate, dibutyl phosphate, etc., are also suitable as catalysts (C). In addition it is also possible here, however, to employ numerous further organic and inorganic heavy metal compounds and also organic and inorganic Lewis acids or Lewis bases. Moreover, the crosslinking rate may also be increased further or tailored precisely to the particular requirement through the combination of different catalysts or of catalysts with various cocatalysts. Preference is given in this context to mixtures (M) which contain exclusively heavy-metal-free catalysts (C).

The prepolymers (A) are used preferably in blends (M) which, furthermore, additionally contain low molecular mass alkoxysilanes (D). These alkoxysilanes (D) may take on a number of functions. Thus they may for example serve as water scavengers—that is, they are intended to scavenge any traces of moisture present and so to increase the storage stability of the corresponding silane-crosslinking compositions (M). As will be appreciated, their reactivity to traces of moisture must be at least comparable with that of the prepolymer (A). Particularly suitable water scavengers are therefore highly reactive alkoxysilanes (D) of the general formulae [1]-[6] and also of the general formula [9]

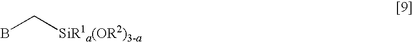

where
B is an OH, SH or NH₂ group or a group OR⁷, SR⁷, NHR⁷ or N(R⁷)₂ and
R¹, R², R⁷, and a are as defined for the general formulae [1] to [3].

One particularly preferred water scavenger here is the carbamatosilane in which B is a group R⁷O—CO—NH.

Furthermore, the low molecular mass alkoxysilanes (D) may also serve as crosslinkers and/or reactive diluents. Suitable in principle for this purpose are all silanes which possess reactive alkoxysilyl groups by which they can be incorporated into the three-dimensional network which forms as the polymer blend (M) cures. The alkoxysilanes (D) may contribute to an increase in the network density and hence to an improvement in the mechanical properties, such as tensile strength, of the cured composition (M). Moreover, they may also lower the viscosity of the corresponding prepolymer blends (M). Examples of suitable alkoxysilanes (D) in this function include alkoxymethyltrialkoxysilanes and alkoxymethyldialkoxyalkylsilanes. Alkoxy groups in this context are preferably methoxy and ethoxy groups. Moreover, the inexpensive alkyltrimethoxysilanes, such as methyltrimethoxysilane, and also vinyl- or phenyltrimethoxysilane, and their partial hydrolyzates, may also be suitable.

Additionally the low molecular mass alkoxysilanes (D) may serve as adhesion promoters. Here it is possible in particular to use alkoxy silanes which possess amino functions or epoxy functions. Examples include γ-aminopropyltrialkoxysilanes, γ-[N-aminoethylamino]propyltrialkoxysilanes, γ-glycidyloxypropyltrialkoxysilanes, and all silanes of the general formula [8] wherein B is a nitrogen-containing group.

Finally, the low molecular mass alkoxysilanes (D) may even serve as curing catalysts or curing cocatalysts. Particularly suitable for this purpose are all basic aminosilanes, such as, for example, all aminopropylsilanes, N-aminoethylaminopropylsilanes, and also all silanes of the general formula [8] where B is a nitrogen-containing group.

The alkoxysilanes (D) can be added to the prepolymers (A) at any desired point in time. Insofar as they do not possess NCO-reactive groups, they may even be added during the synthesis of the prepolymers (A). In that case it is possible, per 100 parts by weight of prepolymer (A), to add up to 100 parts by weight, preferably 1 to 40 parts by weight, of a low molecular mass alkoxysilane (D).

Furthermore, blends of the alkoxysilane-terminated prepolymers (A) are typically admixed with fillers (E). These fillers (E) lead to a considerable improvement in the properties of the resultant blends (M). In particular, both the tensile strength and the breaking elongation can be increased considerably through the use of appropriate fillers. The breaking elongation of the blends (M) after curing is preferably >4 MPa, in particular >5 MPa.

Suitable fillers (E) here are all materials of the kind widely described in the prior art. Examples of fillers are nonreinforcing fillers, i.e., fillers having a BET surface area of up to 50 m²/g, such as quartz, diatomaceous earth, calcium silicate, zirconium silicate, zeolites, calcium carbonate, metal oxide powders, such as aluminum, titanium, iron or zinc oxides and their mixed oxides, barium sulfate, calcium carbonate, gypsum, silicon nitride, silicon carbide, boron nitride, glass powders and polymeric powders; reinforcing fillers, i.e., fillers having a BET surface area of at least 50 m²/g, such as pyrogenically prepared (fumed) silica, precipitated silica, carbon black, such as furnace black and acetylene black, and high-BET-surface-area mixed silicon aluminum oxides; fibriform fillers, such as asbestos, and also polymeric fibers. Said fillers may have been rendered water repellent, such as by treatment with organosilanes and/or organosiloxanes or by etherification of hydroxyl groups to alkoxy groups, for example. It is possible to use one kind of filler, and it is also possible to use a mixture of at least two fillers.

The fillers (E) are employed preferably in a concentration of 0-90% by weight, based on the completed blend (M), particular preference being given to concentrations of 30-70% by weight. In one preferred application use is made of filler combinations (E) which as well as calcium carbonate also include fumed silica and/or carbon black.

The blends (M) comprising the prepolymers (A) may also, furthermore, include small amounts of an organic solvent (F). The purpose of this solvent is to lower the viscosity of the uncrosslinked compositions (M). Suitable solvents (F) include in principle all solvents and also solvent mixtures. Solvents (F) used are preferably compounds which have a dipole moment. Particularly preferred solvents possess a heteroatom having free electron pairs which are able to enter into hydrogen bonds. Preferred examples of such solvents are ethers such as tert-butyl methyl ether, esters, such as ethyl acetate or butyl acetate, and alcohols, such as methanol, ethanol, n-butanol, and tert-butanol, for example. The solvents (F) are used preferably in a concentration of 0-20% by volume, based on the completed prepolymer mixture (M) including all fillers (E), particular preference being given to solvent concentrations of 0-5% by volume.

As further components the polymer blends (M) may comprise conventional auxiliaries, such as water scavengers and/or reactive diluents other than the components (D), and also adhesion promoters, plasticizers, thixotropic agents, fungicides, flame retardants, pigments, etc. Additionally, light stabilizers, antioxidants, free-radical scavengers, and other stabilizers may be added to the compositions (M).

For the purpose of generating the particular desired profiles of properties, not only of the uncrosslinked polymer blends (M) but also of the cured compositions (M), additions of this kind are preferred.

For the polymer blends (M) there exist numerous different applications in the areas of adhesives, sealants, including joint sealants, surface coatings, and in the production of shaped parts as well. The polymer blends (M) may be employed either in pure form or in the form of solutions or dispersions.

All of the above symbols in the above formulae have their definitions in each case independently of one another. In all of the formulae the silicon atom is tetravalent.

Unless indicated otherwise, all amounts and percentages are by weight, all pressures are 0.10 MPa (abs.), and all temperatures are 20° C.

### EXAMPLE 1

### Preparation of N-[(methyldiethoxysilyl)methyl]piperazine

377 g (4.4 mol) of piperazine and 566 g of dioxane as solvent are charged to a 2-liter 4-necked flask and then rendered inert with nitrogen. This initial charge is heated at a temperature of 90° C. until the piperazine is fully dissolved. The solution is then cooled to 80° C. At this temperature 179.2 g (0.88 mol) of chloromethylmethyldiethoxysilane are added dropwise over 2 h and the mixture is stirred at 80° C. for a further 2 hours. The addition of approximately ⅓ of the quantity of silane is followed by increasing precipitation of piperazine hydrochloride salt, although the suspension remains readily stirrable until the end of the reaction. The suspension is left to stand overnight. The precipitated salt is then filtered off and the solvent and also parts of the excess piperazine are removed distillatively at 60-70° C. The residue is cooled to 4° C., the piperazine remaining in the reaction mixture being precipitated. This precipitate is filtered off. The filtrate is purified distillatively (108-114° C. at 8 mbar). A yield is achieved of 123.4 g, i.e., approximately 60% based on the amount of silane employed.

### EXAMPLE 2

### Preparation of N-[(triethoxysilyl)methyl]piperazine

430.7 g (5.0 mol) of piperazine and 646 g of dioxane as solvent are charged to a 2-liter 4-necked flask and then rendered inert with nitrogen. This initial charge is heated to a temperature of 90° C. until the piperazine is fully dissolved. The solution is then cooled to 80° C. At this temperature 212.8 g (1.0 mol) of chloromethyltriethoxysilane are added dropwise over 2 h and the mixture is stirred at 80° C. for a further 2 hours. The addition of approximately ⅓ of the quantity of silane is followed by increasing precipitation of piperazine hydrochloride salt, although the suspension remains readily stirrable until the end of the reaction. The suspension is left to stand overnight. The precipitated salt is then filtered off and the solvent and also parts of the excess piperazine are removed distillatively at 60-70° C. The residue is cooled to 4° C., the piperazine remaining in the reaction mixture being precipitated. This precipitate is filtered off. The filtrate is purified distillatively (88-90° C. at 0.4 mbar). A yield is achieved of 162.7 g, i.e., approximately 62% based on the amount of silane employed.

### EXAMPLE 3

### Preparation of methyl triethoxysilylmethylcarbamate

61.3 g (7.56 mol) of extra finely ground potassium isocyanate are weighed out into a 1-liter 4-necked flask. Introduced subsequently are 404 g (0.51 l, 12.6 mol) of methanol, 184.0 g (0.196 l) of dimethylformamide and 125.5 g (0.59 mol) of chloromethyltriethoxysilane. With stirring, the reaction mixture is heated to boiling and held at reflux for a total of 10 h, the boiling temperature rising from 100° C. to 128° C. and then remaining stable. After cooling to room temperature, the potassium chloride formed is separated off on a suction filter and the filter cake is washed with 1.1 l of methanol. The methanol and dimethylformamide solvents are removed on a rotary evaporator. The amounts of potassium chloride that remain are separated off. The crude solution is purified distillatively (84-89° C. at 3 mbar). A total of 73.6 g (53% of theory) of product are obtained.

### EXAMPLE 4

### Determination of the Stability of α-aminomethylsilanes in the Presence of Methanol

General instructions: the α-aminosilane is dissolved in methanol-D4 (10% by weight). The resulting solution is subjected to repeated measurement by ¹H NMR spectroscopy. The half-life (t_{1/2}) of the α-aminosilane is determined using the integrals of the methylene spacer ═N—CH₂—Si(O)R₃ in the undecomposed α-aminosilane (δ approx. 2.2 ppm) and also the integral of the methyl group ═NCH₂D obtained as decomposition product (cleavage of the Si—C bond) (δ approx. 2.4 ppm).

### EXAMPLE 5

### Preparation of a Silane-Terminated Prepolymer (A)

A 250 ml reaction vessel with stirring, cooling and heating facilities is charged with 152 g (16 mmol) of a polypropylene glycol having an average molecular weight of 9500 g/mol (Acclaim® 12200 from Bayer) and this initial charge is dewatered at 80° C. under vacuum for 30 minutes. Subsequently, at this temperature and under nitrogen, 2.16 g (24 mmol) of 1,4-butanediol, 12.43 g (56 mmol) of isophorone diisocyanate and 80 mg of dibutyltin dilaurate (corresponding to a tin content of 100 ppm) are added. Stirring is carried out at 80° C. for 60 minutes. The NCO-terminated polyurethane prepolymer obtained is thereafter cooled to 60° C., admixed with 11.90 g (51.2 mmol) of N-[(methyldiethoxysilyl)methyl]piperazine and stirred at 80C for 60 minutes. The viscosity is reduced by addition of 9 g of ethanol (about 5% by weight, based on the completed prepolymer). The result is a prepolymer mixture which, with a viscosity of approximately 200 Pas at 20° C., can be poured and further-processed without problems. By IR spectroscopy it is no longer possible to detect any isocyanate groups.

### EXAMPLE 6

### Preparation of a Silane-Terminated Prepolymer (A)

A 250 ml reaction vessel with stirring, cooling and heating facilities is charged with 152 g (16 mmol) of a polypropylene glycol having an average molecular weight of 9500 g/mol (Acclaim® 12200 from Bayer) and this initial charge is dewatered at 80° C. under vacuum for 30 minutes. Subsequently, at this temperature and under nitrogen, 2.16 g (24 mmol) of 1,4-butanediol, 12.43 g (56 mmol) of isophorone diisocyanate and 80 mg of dibutyltin dilaurate (corresponding to a tin content of 100 ppm) are added. Stirring is carried out at 80° C. for 60 minutes. The NCO-terminated polyurethane prepolymer obtained is thereafter cooled to 60° C., admixed with 13.44 g (51.2 mmol) of N-[(triethoxysilyl)methyl]-piperazine and stirred at 80° C. for 60 minutes. The viscosity is reduced by addition of 9 g of ethanol (about 5% by weight, based on the completed 5 prepolymer). The result is a prepolymer mixture which, with a viscosity of approximately 200 Pas at 20° C., can be poured and further-processed without problems. By IR spectroscopy it is no longer possible to detect any isocyanate groups.

### EXAMPLE 7

### Preparation of a Silane-Terminated Prepolymer (A)

A 250 ml reaction vessel with stirring, cooling and heating facilities is charged with 152 g (16 mmol) of a polypropylene glycol having an average molecular weight of 9500 g/mol (Acclaim® 12200 from Bayer) and this initial charge is dewatered at 80° C. under vacuum for 30 minutes. Subsequently, at this temperature and under nitrogen, 2.16 g (24 mmol) of 1,4-butanediol, 12.43 g (56 mmol) of isophorone diisocyanate and 80 mg of dibutyltin dilaurate (corresponding to a tin content of 100 ppm) are added. Stirring is carried out at 80° C. for 60 minutes. The NCO-terminated polyurethane prepolymer obtained is thereafter cooled to 60° C., admixed with 9.24 g (35.2 mmol) of N-[(triethoxysilyl)methyl]piperazine and stirred at 80° C. for 60 minutes. The viscosity is reduced by addition of 9 g of ethanol (about 5% by weight, based on the completed prepolymer). The result is a prepolymer mixture which, with a viscosity of approximately 380 Pas at 20° C., can be poured and further-processed well only at a relatively high temperature. (Here, however, it is possible to add the additional alkoxysilanes (D) that are present in the completed blend (M) to the prepolymer during its actual preparation, and thereby to lower its viscosity.) By IR spectroscopy it is no longer possible to detect any isocyanate groups.

### EXAMPLE 8

### Preparation of a Silane-Terminated Prepolymer (A)

A 250 ml reaction vessel with stirring, cooling and heating facilities is charged with 160 g (20 mmol) of a polypropylene glycol having an average molecular weight of 8000 g/mol (Acclaim® 8200 from Bayer) and this initial charge is dewatered at 80° C. under vacuum for 30 minutes. Subsequently, at this temperature and under nitrogen, 2.70 g (30 mmol) of 1,4-butanediol, 15.54 g (70 mmol) of isophorone diisocyanate and 85 mg of dibutyltin dilaurate (corresponding to a tin content of 100 ppm) are added. Stirring is carried out at 80° C. for 60 minutes. The NCO-terminated polyurethane prepolymer obtained is thereafter cooled to 60° C., admixed with 14.87 g (64 mmol) of N-[(methyldiethoxysilyl)methyl]piperazine and stirred at 80° C. for 60 minutes. The viscosity is reduced by addition of 9.8 g of ethyl acetate (about 5% by weight, based on the completed prepolymer). The result is a prepolymer mixture which, with a viscosity of 120 Pas at 20° C., can be poured and further-processed without problems. By IR spectroscopy it is no longer possible to detect any isocyanate groups.

### EXAMPLE 9

### Preparation of a Silane-Terminated Prepolymer (A)

A 250 ml reaction vessel with stirring, cooling and heating facilities is charged with 160 g (20 mmol) of a polypropylene glycol having an average molecular weight of 8000 g/mol (Acclaim® 8200 from Bayer) and this initial charge is dewatered at 80° C. under vacuum for 30 minutes. Subsequently, at this temperature and under nitrogen, 3.00 g (40 mmol) of 2-(methylamino)ethanol, 17.76 g (80 mmol) of isophorone diisocyanate and 85 mg of dibutyltin dilaurate (corresponding to a tin content of 100 ppm) are added. Stirring is carried out at 80° C. for 60 minutes. The NCO-terminated polyurethane prepolymer obtained is thereafter cooled to 60° C., admixed with 14.87 g (64 mmol) of N-[(methyldiethoxysilyl)methyl]piperazine and stirred at 80° C. for 60 minutes. By IR spectroscopy it is no longer possible to detect any isocyanate groups in the resulting prepolymer. Even without the addition of solvent the prepolymer, with a viscosity of 140 Pas, can be poured and further-processed without problems. Following the addition of 5.9 g of ethanol (approximately 3% by weight, based on the completed prepolymer) the viscosity is still approximately 50 Pas.

### COMPARATIVE EXAMPLE 1

### Preparation of a Noninventive Silane-Terminated Prepolymer

This comparative example is directly comparable with example 5. Here, however, the silane component used, instead of the N-[(methyldiethoxysilyl)methyl]piperazine, is an equimolar amount of N-cyclohexylaminomethyldimethoxymethylsilane. All other components are unchanged as compared with example 5.

A 250 ml reaction vessel with stirring, cooling and heating facilities is charged with 152 g (16 mmol) of a polypropylene glycol having an average molecular weight of 9500 g/mol (Acclaim® 12200 from Bayer) and this initial charge is dewatered at 80° C. under vacuum for 30 minutes. Subsequently, the heating is removed and under nitrogen, 2.16 g (24 mmol) of 1,4-butanediol, 12.43 g (56 mmol) of isophorone diisocyanate and 80 mg of dibutyltin dilaurate (corresponding to a tin content of 100 ppm) are added. Stirring is carried out at 80° C. for 60 minutes. The NCO-terminated polyurethane prepolymer obtained is thereafter cooled to 75° C., admixed with 12.77 g (51.2 mmol) of N-cyclohexylaminomethyldiethoxymethylsilane and stirred at 80° C. for 60 minutes. The viscosity is reduced by addition of 9 g of ethanol (about 5% by weight, based on the completed prepolymer). The result is a prepolymer mixture which, with a viscosity of approximately 100 Pas at 20° C., can be poured and further-processed without problems. By IR spectroscopy it is no longer possible to detect any isocyanate groups.

### EXAMPLE 10

### Production of Moisture-Curing Blends (M) Comprising Prepolymers (A)

General instructions (the specific quantities of the individual components can be found in Table 1. Where certain components are absent, the respective steps of incorporation are not carried out):

The prepolymer indicated in Table 1 is admixed with carbamatomethyltrimethoxysilane (silane 1) and mixed for 15 seconds at 27 000 rpm in a Speedmixer (DAC 150 FV from Hausschild). The chalk (BLR 3 from Omya), finely divided silica WACKER HDK® V 15 (Wacker Chemie GmbH, Germany) and mixing takes place for 2 times 20 seconds at a rotational speed of 30 000 rpm. Finally aminopropyltrimethoxysilane (silane 2) is added and mixing takes place likewise for 20 seconds at a rotational speed of 30 000 rpm.

TABLE 1

| Example number | C Ex. 1* | Ex. 5 | Ex. 6 |
|---|---|---|---|
| Polymer from example | C Ex. 1* | Ex. 5 | Ex. 6 |
| Polymer content | 60% | 60% | 60% |
| Chalk BLR 3 | 30% | 30% | 30% |
| WACKER HDK ® V-15 | 5% | 5% | 5% |
| Silane 1 | 3% | 3% | 3% |
| Silane 2 | 2% | 2% | 2% |

| Example number | Ex. 7 | Ex. 8-1 | Ex. 8-2 |
|---|---|---|---|
| Polymer type | Ex. 7 | Ex. 8 | Ex. 8 |
| Polymer content | 60% | 60% | 96% |
| Chalk BLR 3 | 30% | 30% | — |
| WACKER HDK ® V-15 | 5% | 5% | — |
| Silane 1 | 3% | 3% | 2% |
| Silane 2 | 2% | 2% | 2% |

| Example number | Ex. 8-3 | Ex. 9 |
|---|---|---|
| Polymer type | Ex. 8 | Ex. 9 |
| Polymer content | 57.5% | 60% |
| Chalk BLR 3 | 30% | 30% |
| WACKER HDK ® V-15 | 7.5% | 5% |
| Silane 1 | 3% | 3% |
| Silane 2 | 2% | 2% |

*Not inventive

### EXAMPLE 11

### Properties of the Cured Blends (M) Comprising Prepolymers (A)

The completed prepolymer blend is spread using a doctor blade into a Teflon® mold 2 mm high, the rate of volume cure being approximately 2 mm per day. After two-week storage, S1 test specimens are punched out, and their tensile properties are measured in accordance with EN ISO 527-2 on the Z010 from Zwick. The properties determined for each of the prepolymer blends are listed in Table 2. The noninventive, comparative example 1 (C. Ex. 1) is directly comparable with the inventive example 5 (Ex. 5).

TABLE 2

| Example number | C Ex. 1* | Ex. 5 | Ex. 6 |
|---|---|---|---|
| Skinning time | 90 min | 5 min | 7 min |
| Tensile strength [MPa] | 4.0 | 5.5 | 5.4 |
| Breaking elongation [%] | 650 | 525 | 437 |
| Modulus [MPa] | 1.2 | 1.4 | 1.9 |
| Shore hardness | 50 | 64 | 58 |

| Batch number | Ex. 7 | Ex. 8-1 | Ex. 8-2 |
|---|---|---|---|
| Skinning time | 4 min | 5 min | 60 min |
| Tensile strength [MPa] | 5.5 | 5.4 | 3.2 |
| Breaking elongation [%] | 443 | 507 | 453 |
| Modulus [MPa] | 1.8 | 2.1 | 0.97 |
| Shore hardness | 68 | 69 | 51 |

| Batch number | Ex. 8-3 | Ex. 9 |
|---|---|---|
| Skinning time | 3 min | 10 min |
| Tensile strength [MPa] | 6.8 | 5.1 |
| Breaking elongation [%] | 545 | 306 |
| Modulus [MPa] | 2.5 | 2.5 |
| Shore hardness | 71 | 67 |

*Not inventive

1.-10. (canceled)

11. An alkoxysilane-functional prepolymer (A) obtained from an aminomethyl-functional alkoxysilane (A1), the prepolymer (A) possessing at least one structural element of the formula [1] 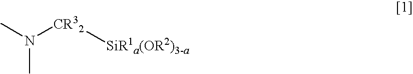
in which
R¹ is an optionally substituted hydrocarbon radical or a ═N—CR³₂ group,
R² is an alkyl radical having 16 carbon atoms or an ω-oxaalkyl-alkyl radical having in total 2-10 carbon atoms,
R³ is hydrogen or an optionally substituted hydrocarbon radical, and
a is 0, 1 or 2,
the nitrogen atom in the formula [1] being a tertiary nitrogen atom and the alkoxysilane (A1) possessing at least one isocyanate-reactive functionality (F).

12. The alkoxysilane-functional prepolymer (A) of claim 11, wherein the radicals R¹ have 1 to 12 C atoms.

13. The alkoxysilane-functional prepolymer (A) of claim 11, wherein the radicals R² are methyl or ethyl groups.

14. The alkoxysilane-functional prepolymer (A) of claim 12, wherein the radicals R² are methyl or ethyl groups.

15. The alkoxysilane-functional prepolymer (A) of claim 11, wherein the functionality (F) is selected from NH, OH or SH.

16. The alkoxysilane-functional prepolymer (A) of claim 11, wherein the alkoxysilanes (A1) are of the formula [2], [3], or mixtures thereof: 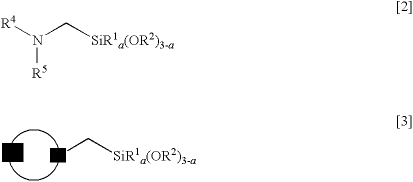
where
R⁴ is an optionally substituted alkyl, aryl or arylalkyl radical which possesses at least one carboxyl or carbonyl group or an isocyanate-reactive OH, SH or NHR⁷ group, the alkyl chain optionally interrupted by non-adjacent oxygen, carbonyl groups, sulfur or NR⁷ groups,
R⁵ is an optionally substituted alkyl, aryl or arylalkyl radical, the alkyl chain optionally interrupted by non-adjacent oxygen, carbonyl groups, sulfur or NR⁷ groups, or R⁵ is a radical R⁴,
R⁶ is a difunctional, optionally substituted alkyl or arylalkyl radical which either in the alkyl chain possesses a carbonyl group or an isocyanate-reactive NH functionality or an NR⁴ functionality, or is substituted by at least one isocyanate-reactive OH, SH or NHR⁷ group, the alkyl chain optionally interrupted by oxygen, sulfur, NR⁷ groups or carbonyl groups, and
R⁷ is hydrogen or an optionally substituted alkyl, aryl or arylalkyl radical.

17. The alkoxysilane-functional prepolymer (A) of claim 11, wherein the alkoxysilanes (A1) are of the formula [4] 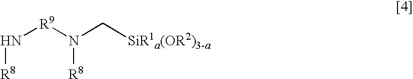
where
R⁸ is alkyl radical having 1-4 carbon atoms, and
R⁹ is a difunctional alkyl radical having 2-10 carbon atoms.

18. The alkoxysilane-functional prepolymer (A) of claim 11, wherein the alkoxysilanes (A1) are of the formula [5] or [6] 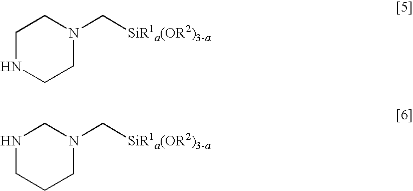
where
R¹ is an optionally substituted hydrocarbon radical or a ═N—CR³₂ group,
R² is an alkyl radical having 16 carbon atoms or an ω-oxaalkyl-alkyl radical having in total 2-10 carbon atoms,
R³ is hydrogen or an optionally substituted hydrocarbon radical, and
a is 0, 1 or 2,
the nitrogen atom in the formula [1] being a tertiary nitrogen atom and the alkoxysilane (A1) possessing at least one isocyanate-reactive functionality (F).

19. A process for preparing the alkoxysilane-functional prepolymer (A) of claim 11, wherein one or more silanes of the general formulae [2] to [6] 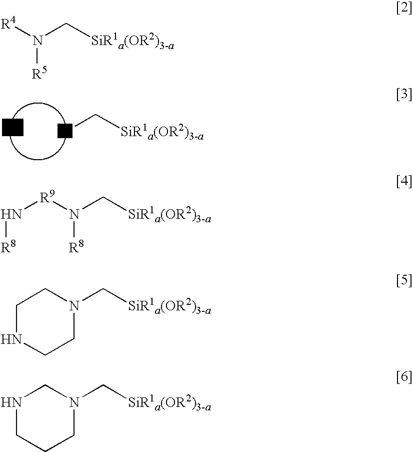
where
R¹ is an optionally substituted hydrocarbon radical or a ═N—CR³₂ group,
R² is an alkyl radical having 16 carbon atoms or an ω-oxaalkyl-alkyl radical having in total 2-10 carbon atoms,
R³ is hydrogen or an optionally substituted hydrocarbon radical,
a is 0, 1 or 2,
the nitrogen atom in the formula [1] being a tertiary nitrogen atom and the alkoxysilane (A1) possessing at least one isocyanate-reactive functionality (F),
R⁴ is an optionally substituted alkyl, aryl or arylalkyl radical which possesses at least one carboxyl or carbonyl group or an isocyanate-reactive OH, SH or NHR⁷ group, the alkyl chain optionally interrupted by non-adjacent oxygen, carbonyl groups, sulfur or NR⁷ groups,
R⁵ is an optionally substituted alkyl, aryl or arylalkyl radical, the alkyl chain optionally interrupted by non-adjacent oxygen, carbonyl groups, sulfur or NR⁷ groups, or R⁵ is a radical R⁴,
R⁶ is a difunctional, optionally substituted alkyl or arylalkyl radical which either in the alkyl chain possesses a carbonyl group or an isocyanate-reactive NH functionality or an NR⁴ functionality, or is substituted by at least one isocyanate-reactive OH, SH or NHR⁷ group, the alkyl chain optionally interrupted by oxygen, sulfur, NR⁷ groups or carbonyl groups,
R⁷ is hydrogen or an optionally substituted alkyl, aryl or arylalkyl radical,
R⁸ is alkyl radical having 1-4 carbon atoms,
R⁹ is a difunctional alkyl radical having 2-10 carbon atoms,
a) are reacted with an isocyanate-terminated prepolymer (A2), or
b) are reacted with an NCO-containing precursor of the prepolymer (A) to give a silyl-containing precursor, which is then reacted in further reaction steps to give the completed prepolymer (A).

20. The process of claim 19, wherein the proportions of the individual components are selected such that all of the isocyanate groups present in the reaction mixture are consumed by reaction.

21. A mixture (M) comprising the prepolymers (A) in accordance with claim 11.

22. A mixture (M) of claim 21 which is a moisture curable mixture further comprising at least one dialkoxysilane or trialkoxysilane.

23. The mixture (M) of claim 22, which liberates only ethanol upon cure.
